(19) United States
(12) Patent Application Publication
(10) Pub. No.: US 2009/0083432 A1
(43) Pub. Date: Mar. 26, 2009

(54) Traffic control system and traffic control method

(76) Inventors: Hiroshi Saito, Kawasaki (JP); Shinichi Hayashi, Kawasaki (JP); Yukio Ogawa, Tokyo (JP); Yuji Kimura, Kawasaki (JP); Takahide Sabuchi, Funabashi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/230,458

(22) Filed: Aug. 29, 2008

(30) Foreign Application Priority Data
Aug. 31, 2007 (JP) 2007-226566

(51) Int. Cl. G06F 15/16

(52) U.S. Cl. 709/231

(57) ABSTRACT

A traffic control system 100 includes: a quality measuring unit 110 that measures communication quality on a communication line A between a relay server 300 and a client terminal 400; an upstream specifying unit 111 that specifies an amount of streaming data, in a communication line B between a video streaming server 200 and the relay server 300, corresponding to an amount of screen information of a communication data amount accepted for the measured communication quality a of the communication line A; and an upstream control unit 112 that performs control such that an amount of video data to be distributed to the relay server 300 from the video streaming server 200 via the communication line B can be adjusted to the specified amount of streaming data.

### INCORPORATION BY REFERENCE

This application claims priority based on a Japanese patent application, No. 2007-226566 filed on Aug. 31, 2007, the entire contents of which are incorporated herein by reference.

### BACKGROUND OF THE INVENTION

The present invention relates to a traffic control system and a traffic control method, and more particularly relates to a technique for managing video streaming in different communication lines according to quality of each communication line, the different communication lines being respectively used for coupling between a video streaming server and a relay server (thin client server) receiving streaming data from the video streaming server, and coupling between the relay server and a client terminal (thin client terminal) receiving the reproduced streaming data from the relay server.

Streaming contents such as videos are likely to impose a heavy load on a network. Thus, there is a need to perform an appropriate distribution management according to a communication environment when such contents are distributed. As a technique to meet the foregoing demand, for example, there is proposed a server-client communication system, as seen in for example Japanese Patent Application Laid-open Publication No. 2004-146895, including: an application server that manages streaming contents; a client terminal that receives contents distributed by the application server via a network and reproduces the contents; and a control server that controls the client terminal on the basis of a communication environment where the client terminal reproduces the contents. Moreover, in this system, the client terminal notifies the control server of a contents reproduction condition obtained when reproducing the contents received from the application server. The control server determines whether or not the contents can be normally reproduced by the client terminal on the basis of the contents reproduction condition notified from the client terminal via a network to thereby verify a communication environment used when the contents are reproduced by the client terminal, and instructs the client terminal to present to a user the contents according to the communication environment.

### SUMMARY OF THE INVENTION

Meanwhile, in order to meet a demand for a countermeasure against information leakage and internal control in a company or the like, an idea of a thin client has appeared. In this idea, a dedicated client computer (thin client terminal) provided with minimum functions such as a display, an input and the like while excluding a hard disk device and the like is used as a client computer, and sources such as application software and the like are integrally managed by a server (thin client server).

Under the aforementioned thin client environment, screen information of GUI executed by the thin client server is transmitted to the thin client terminal irrespective of the type of the application. For example, in Remote Desktop (Microsoft Corporation) communications, screen information of the thin client server transmitted to the thin client terminal is difference information representing changes in image. Thus, a high screen update frequency results in an increase in the difference information.

For this reason, when the screen update occurs frequently under a circumstance where line quality between the thin client server and the thin client terminal is poor (for example, a small bandwidth, a large transmission delay, and the like), transmission of the difference information is delayed, so that the screen, when seen from the user, looks like it is not updated smoothly. Moreover, such frequent screen update may cause other problems that congestion occurs in a network, and that traffic even in an uplink (client to server) direction is affected in a half-duplex network (network such as an ADSL or the like where uplink and downlink communication quality is asymmetric), so that data inputted through a mouse or a keyboard is not normally transmitted. Particularly, these problems appear remarkably under a circumstance where reproduced data of a video image is transmitted to the thin client terminal from the thin client server. This problem is caused because there is no mechanism with which screen image is transmitted according to the network quality between the server and the client.

The present invention is made in view of the aforementioned problems, and an object of the present invention is to provide a technique for transmitting, to a client, screen information produced during video reproduction by a server according to the network quality.

In order to solve the aforementioned problem, the present invention provides a traffic control system which is an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the traffic control system including: a quality measuring unit configured to measure communication quality on a communication line A between the relay server and the client terminal; an upstream specifying unit configured to specify an amount of streaming data, in a communication line B between the video streaming server and the relay server, corresponding to an amount of the screen information of a communication data amount accepted for the measured communication quality a of the communication line A; and an upstream control unit configured to perform control such that an amount of video data distributed to the relay server from the video streaming server via the communication line B can be adjusted to the specified amount of streaming data. This configuration makes it possible to perform control to adjust the amount of video data distributed to the relay server from the video streaming server via the communication line B (upstream) according to communication quality of the communication line A (downstream) and to transmit, to the client, screen information produced during video reproduction by the server according to network quality.

Moreover, the present invention provides a traffic control system which is an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the traffic control system including: a quality measuring unit configured to measure communication quality on a communication line A between the relay server and the client terminal; and a downstream control unit configured to perform control such that an amount of screen information transmitted to the client terminal from the relay server via the communication line A can be adjusted to a communication data amount accepted for the measured communication quality a of the communication line A. This configuration makes it possible to perform control to adjust the amount of screen information distributed to the client terminal from the relay server via the communication line A (downstream) according to communication quality of the communication line A (downstream) and to transmit, to the client, screen information produced during video reproduction by the server according to network quality.

Further, in the traffic control system, the quality measuring unit may be included in any one of the client terminal, the relay server, and an external device disposed in a path of the communication line A, and measure at least one of a bandwidth or transmission speed of the communication line A. This makes it possible for the traffic control system to obtain information on a bandwidth or transmission speed of the communication line A and to efficiently use the obtained information for performing control by the upstream control unit and the downstream control unit.

Moreover, in the traffic control system, the upstream specifying unit may include upstream-downstream correspondence data describing a relation between an amount of streaming data which is received by the relay server from the video streaming server via the communication line B and then is subjected to reproduction processing by the relay server, and an amount of screen information transmitted to the communication line A from the relay server in response to the reproduction processing, and the upstream specifying unit may check the amount of screen information of the communication data amount accepted for the communication quality a in the upstream-downstream correspondence data, and specify an amount of streaming data, in the communication line B, corresponding to the amount of screen information. This makes it possible to efficiently specify the amount of streaming data in the communication line B by the upstream-downstream correspondence data.

Furthermore, in the traffic control system, the upstream control unit may perform any one of processing of instructing the relay server to assign the specified amount of streaming data as video streaming quality to be requested to the video streaming server by the relay server requests, and processing of assigning, to the video streaming server, the specified amount of streaming data as video streaming quality to be used for vide streaming distribution to the relay server by the video streaming server. This makes it possible to reduce an amount of streaming data in advance at the time of video streaming from the video streaming server and to perform video streaming suitable for the communication quality of the communication line A.

Moreover, in the traffic control system, the upstream control unit may be a band control device that performs control to adjust a bandwidth of the communication line B. This makes it possible to directly control communication quality of the communication line B without need for controlling a data distribution source, thus allowing simple and efficient processing by the upstream control unit.

Further, in the traffic control system, the downstream control unit may include quality correspondence data describing a relation between a communication data amount accepted for the communication quality of a communication line and the amount of screen information corresponding to the communication data amount, and the downstream control unit may check the communication data amount accepted for the communication quality a in the quality correspondence data to specify the amount of screen information corresponding to the communication data amount, and assign the specified amount of screen information to the relay server as an amount of screen information to be distributed to the thin client terminal by the relay server via the communication line A. This makes it possible to simply and efficiently specify the amount of screen information flowing through the communication line A by the quality correspondence data.

Further, in the traffic control system, the relay server and the client terminal may constitute a thin client system where the relay server may be a thin client server and the client terminal may be a thin client terminal, a protocol of the communication line A may be a protocol for a remote desktop coupling communications, and a protocol of the communication line B may be a protocol for a streaming communications. This makes it possible to apply the traffic control method of the present invention even at the time of video streaming by a thin client system and transmit, to the client, screen information produced during video reproduction by the server according to network quality.

Furthermore, the present invention provides a traffic control method for an information processing system which controls traffic among a video streaming server, a relay server having a video reproduction program for reproducing video data distributed from the video streaming server, and a client terminal that receives screen information corresponding to the reproduced video data from the relay server and outputs the screen information on a screen, the method comprising the information processing system performing quality measuring processing for measuring communication quality on a communication line A between the relay server and the client terminal; the information processing system performing upstream specifying processing for specifying an amount of streaming data, in a communication line B between the video streaming server and the relay server, corresponding to an amount of screen information of a communication data amount accepted for the measured communication quality a of the communication line A; and the information processing system performing upstream control processing for performing control such that an amount of video data distributed to the relay server from the video streaming server via the communication line B can be adjusted to the specified amount of streaming data. This makes it possible to perform control to adjust the amount of video data distributed to the relay server from the video streaming server via the communication line B (upstream) according to communication quality of the communication line A (downstream) and to transmit, to the client, screen information produced during video reproduction by the server according to network quality.

Moreover, the present invention provides a traffic control method for an information processing system which controls traffic among a video streaming server, a relay server having a video reproduction program for reproducing video data distributed from the video streaming server, and a client terminal that receives screen information corresponding to the reproduced video data from the relay server and outputs the screen information on a screen, the method comprising the information processing system performing quality measuring processing for measuring communication quality on a communication line A between the relay server and the client terminal; and the information processing system performing downstream control processing for performing control such that an amount of screen information transmitted to the client terminal from the relay server via the communication line A can be adjusted to a communication data amount accepted for the measured communication quality a of the communication line A. This makes it possible to perform control to adjust the amount of screen information distributed to the client terminal from the relay server via the communication line A (downstream) according to communication quality of the communication line A (downstream) and to transmit, to the client, screen information produced during video reproduction by the server according to network quality.

It should be noted that the aforementioned units may be included in a dedicated computer apparatus as the traffic control system, or may be included in any of the video streaming server, the thin client server and the thin client terminal, and they may be installed at any location as long as necessary processing can be executed.

In addition, the problem disclosed in this application and the solution method to the problem will become clear from the embodiment of the present invention and the drawings.

According to the present invention, screen information produced during video reproduction by the server can be transmitted to the client according to the network quality.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a view showing a network configuration example of a traffic control system of an embodiment;

FIG. 2 is a view showing a configuration example of the traffic control system of the embodiment;

FIG. 3 is a view showing a configuration example of a thin client server of the embodiment;

FIG. 4 is a view showing a configuration example of a thin client terminal of the embodiment;

FIG. 5 is a view showing a configuration example of a video streaming server of the embodiment;

FIGS. 6A and 6B are tables respectively showing data structure examples of: (A) upstream-downstream correspondence data; and (B) quality correspondence data in the embodiment;

FIG. 7 is a flowchart showing a processing flow example 1 of a traffic control method in the embodiment; and

FIG. 8 is a flowchart showing a processing flow example 2 of the traffic control method in the embodiment.

### DETAILED DESCRIPTION OF THE EMBODIMENTS

### System Configuration

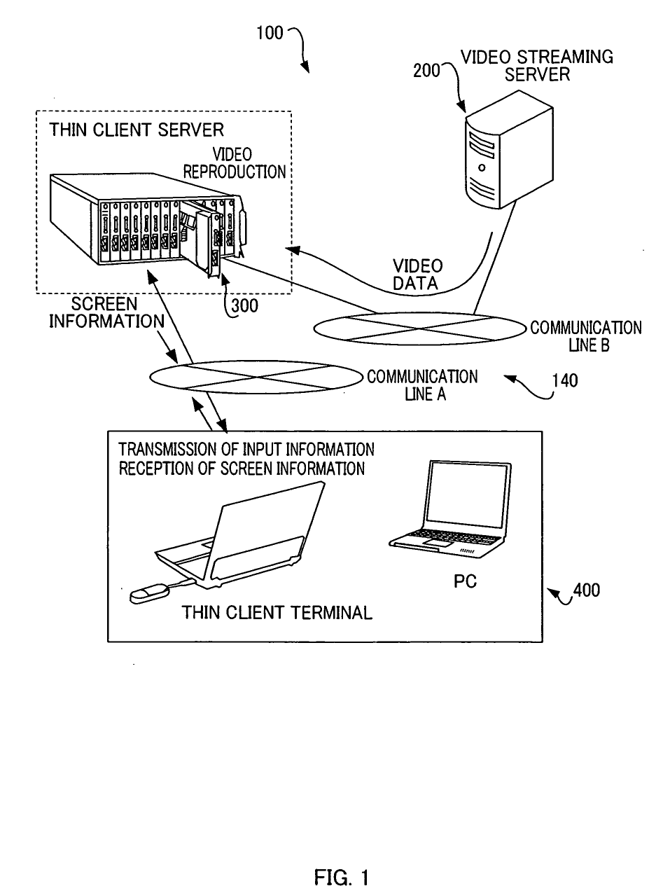

Hereinafter, detailed descriptions will be given of an embodiment of the present invention by use of the accompanying drawings. FIG. 1 is a network configuration diagram of a traffic control system of the present embodiment. A traffic control system 100 shown in FIG. 1 is a system that controls traffic among a video streaming server 200, a thin client server 300 serving as a relay server, and a thin client terminal 400 serving as a client terminal, which are coupled to one another via a network. The thin client server 300 receives streaming data from the video streaming server 200. The thin client terminal 400 remotely controls the thin client server 300 and receives reproduced video data as screen information from the thin client server 300. The traffic system 100 may be a computer which is located on the network and is used as a completely different apparatus from the video streaming server 200, the thin client server 300 and the thin client terminal 400. Alternatively, the traffic system 100 may be configured such that units that the traffic system 100 should be provided with may be collectively or separately disposed on any one of the video streaming server 200, the thin client server 300 and the thin client terminal 400 to thereby provide an apparatus or an apparatus group having the respective units.

It should be noted that the thin client server 300 creates a VPN (Virtual Private Network) between the thin client terminal 400 and itself, receives and processes input information (operation contents inputted by an input device) sent from the thin client terminal 400 via the VPN and transmits, to the thin client terminal 400, image information representing the processed result (a desktop screen of a display device). The thin client server 300 is generally a server apparatus that uses an input/output device without being locally coupled thereto.

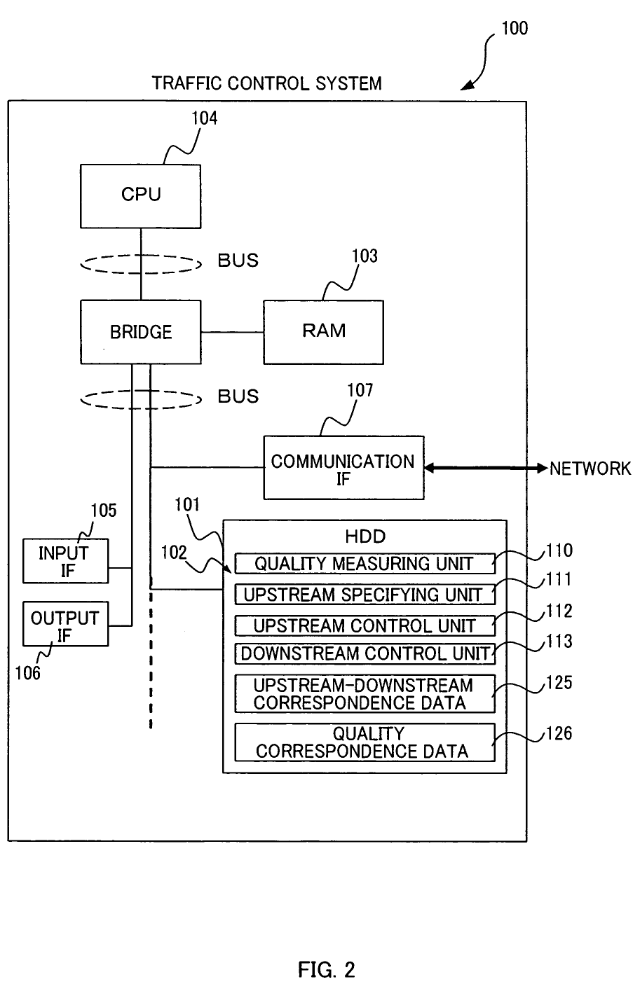

Next, descriptions will be given of the traffic control system 100 of the present embodiment. FIG. 2 is a view showing a configuration example of the traffic control system 100 of the present embodiment. The traffic control system 100 (hereinafter referred to as system 100) reads a program 102 stored in a hard disk drive 101 or the like to a RAM 103 and causes a CPU 104 serving as an arithmetic unit to execute the program 102 in order to include a function that implements the present invention.

Moreover, the traffic control system 100 includes an input interface 105 such as various types of buttons that the computer apparatus generally has, and an output interface 106 such as a display, if necessary, and a communication interface 107 that exchanges data among the video streaming server 200, the thin client terminal 400, the thin client server 300, and the like.

Subsequently, descriptions will be given of functional sections that the traffic control system 100 configures and holds on the basis of the program 102, for example. Here, the traffic control system 100 is assumed to store upstream-downstream correspondence data 125 and quality correspondence data 126 in an appropriate storage device such as a hard disk.

The traffic control system 100 includes a quality measuring unit 110 that measures communication quality of a communication line A between the thin client server 300 serving as the relay server (hereinafter referred to as thin client server 300) and the thin client terminal 400 serving as the client terminal (hereinafter referred to as thin client terminal 400). For example, in a case where the thin client terminal 400 includes the quality measuring unit 110, the thin client terminal 400 performs various types of communication quality measurement such as passive measurement (response time measurement of screen data sent from the thin client server 300 in response to an input operation by the thin client terminal 400, fluctuation measurement of ACK response time and the like) and active measurement (response time measurement of response data sent from the thin client server 300 in response to ping transmission and the like). Alternatively, the similar processing may be performed by a dedicated measuring apparatus (installed on the communication line A). Moreover, in a case where the thin client server 300 includes the quality measuring unit 110, the thin client server 300 performs the passive measurement.

Here, as communication quality that the quality measuring unit 110 measures, for example, at least one of a bandwidth and transmission speed of the communication line A can be assumed. Moreover, data of the communication quality measured by the quality measuring unit 110 is sent to an upstream specifying unit 111.

Further, the traffic control system 100 includes an upstream specifying unit 111 that specifies an amount of streaming data, in a communication line B between the video streaming server 200 and the thin client server 300, corresponding to an amount of screen information of a communication data amount accepted for the measured communication quality a of the communication line A. It can be assumed that the upstream specifying unit 111 is included in, for example, any of the video streaming server 200, the thin client server 300 and the thin client terminal 400 in addition to a dedicated computer apparatus as the traffic control system 100.

It is assumed that the upstream specifying unit 111 includes the upstream-downstream correspondence data 125 which describes a relation between an amount of streaming data and an amount of screen information, the amount of streaming data being the data which the thin client server 300 receives from the video streaming server 200 via the communication line B and on which reproduction processing is performed, the amount of screen information being the information transmitted to the communication line A from the thin client server 300 in response to the reproduction processing. In this case, the upstream specifying unit 111 checks the amount of screen information of the communication data amount accepted for the communication quality a in the upstream-downstream correspondence data 125, and specifies an amount of streaming data, in the communication line B, corresponding to the amount of screen information.

Moreover, the traffic control system 100 includes an upstream control unit 112 that performs control such that an amount of video data distributed to the thin client server 300 from the video streaming server 200 via the communication line B can be adjusted to the specified amount of streaming data. It can be assumed that the upstream control unit 112 is included in, for example, any of the video streaming server 200 and the thin client server 300 in addition to a dedicated computer apparatus as the traffic control system 100.

The upstream control unit 112 instructs the thin client server 300 to assign the specified amount of streaming data as video streaming quality to be requested to the video streaming server 200 by the thin client server 300 requests. Alternatively, the upstream control unit 112 assigns, to the video streaming server 200, the specified amount of streaming data as video streaming quality to be used for vide streaming distribution to the thin client server 300 by the video streaming server 200.

It should be noted that the aforementioned upstream control unit 112 can be regarded as a band control device that performs control to adjust a bandwidth of the communication line B. For instance, PacketShaper® (Packeteer, Inc.) is taken as an example of the band control device.

Furthermore, the traffic control system 100 may include a downstream control unit 113 that performs control such that an amount of screen information sent to the thin client terminal 400 from the thin client server 300 via the communication line A may be adjusted to the communication data amount accepted for the measured communication quality a of the communication line A. It can be assumed that the lower stream control unit 113 is included in, for example, any of the thin client server 300 and the thin client terminal 400 in addition to a dedicated computer apparatus as the traffic control system 100.

It is assumed that the downstream control unit 113 includes quality correspondence data 126 that describes a relation between a communication data amount accepted for the communication quality of the communication line and the amount of screen information corresponding to the communication data amount. In this case, the downstream control unit 113 checks the communication data amount accepted for the communication quality a in the quality correspondence data 126 to specify an amount of screen information corresponding to the communication data amount. Moreover, the downstream control unit 113 assigns, to the thin client server 300, the specified amount of screen information as an amount of screen information that the thin client server 300 distributes to the thin client terminal 400 via the communication line A.

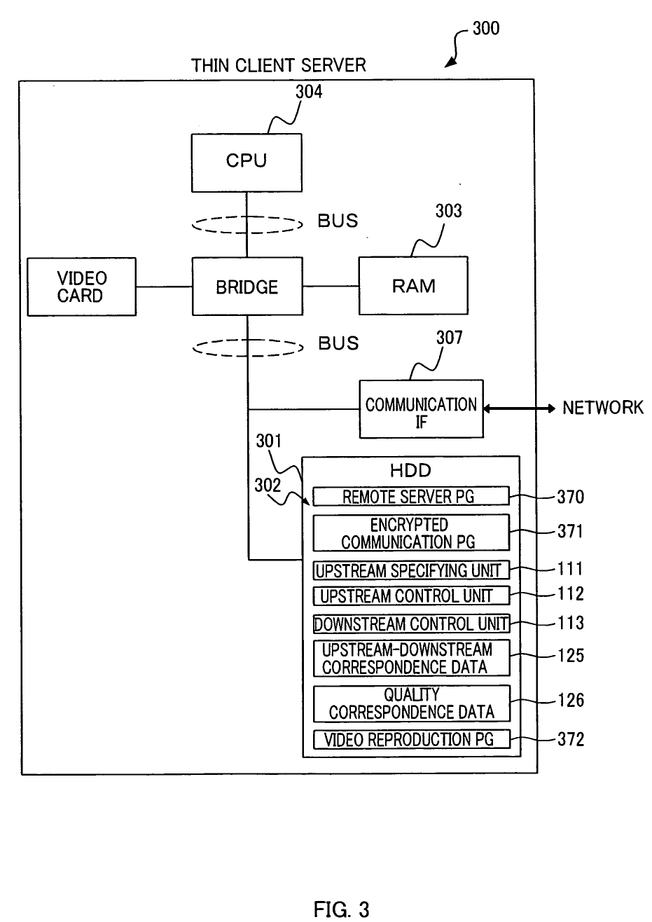

Next, descriptions will be given of the thin client server 300. FIG. 3 is a view showing a configuration example of the thin client server 300 of the present embodiment. The thin client server 300 is a server apparatus that receives a remote access from the thin client terminal 400 and configures a thin client system. Moreover, the thin client server 300 executes video reproduction using a video reproduction program 372 upon reception of streaming data from the video streaming server 200, and transmits screen information, which corresponds to the reproduced data (output image data by a display device in the thin client server 300), to the thin client terminal 400 coupled to the thin client server 300 through a remote desktop coupling.

The above-mentioned thin client server 300 reads a program 302 stored in a HDD (Hard Disk Drive) 301 or the like to a RAM 303 and causes a CPU 304 serving as an arithmetic unit to execute the program 302 in order to include a function that implements the present invention.

Moreover, the thin client server 300 includes an input interface 305 such as various types of keyboards and buttons that the computer apparatus generally has, and an output interface 306 such as a display, if necessary, and a communication interface 307 that exchanges data among the traffic control system 100, the video streaming server 200 and the thin client terminal 400. The foregoing thin client server 300 includes, for example, the program 302 that implements the units 110 to 113 of the system 100.

Further, the thin client server 300 stores a remote server program 370 and an encrypted communication program 371 in the HDD 301. The remote server program 370 is a program for allowing the thin client terminal 400 to remotely control a desktop of the thin client server 300, and a server program of VNC (Virtual Network Computing) developed by AT&T Laboratories Cambridge is taken as an example. The CPU 304 loads the remote server program 370 into the RAM 303 from the HDD 301 to execute the program according to an OS 336. Thereby, the CPU 304 receives and processes input information (operation contents inputted by a keyboard and a mouse) sent from the thin client terminal 400 via a network 140 such as VPN, and transmits image information representing the processing result (desk top screen of the display) to the thin client terminal 400 via the network 140 such as VPN.

Moreover, the encrypted communication program 371 is a communication program for constructing the network 140 such as VPN between the thin client terminal 400 and the thin client server 300, and a communication program using IPsec (Security Architecture for the Internet Protocol) is taken as an example. The CPU 304 loads the encrypted communication program 371 into the RAM 303 from the HDD 301 to execute the program according to the OS. Thereby, according to a coupling establishment request for remote control received from the thin client terminal 400 via the communication interface 307, the CPU 304 constructs the secure network 140 such as VPN between the thin client terminal 400 and the thin client server 300, and performs remote control communications with the thin client terminal 400 via the VPN or the like.

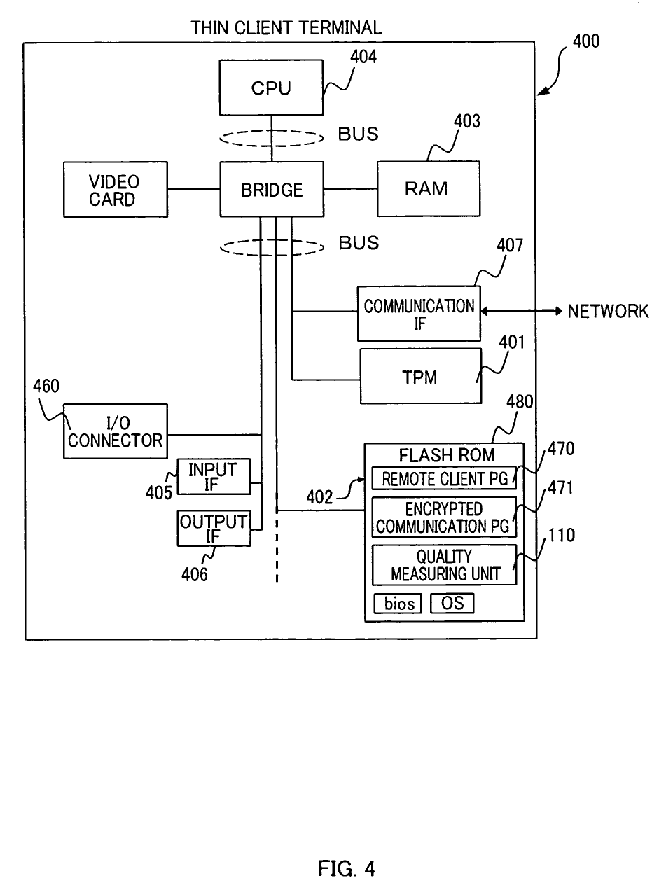

Next, descriptions will be given of the thin client terminal 400. FIG. 4 is a view showing a configuration example of the thin client terminal 400 of the present embodiment. The thin client terminal 400 is an apparatus that gains access to, via the network 140, the thin client server 300 assigned by an appropriate management device and remotely controls the thin client server 300, and configures a thin client system together with the thin client server 300. Further, the thin client terminal 400 is a computer apparatus that receives screen information, from the thin client server 300 which is performing video reproduction, corresponding to the video reproduction data and outputs the received result to a display device.

The above-mentioned thin client terminal 400 reads a program 402 stored in a flash ROM 480 or the like into a RAM 403 and causes a CPU 404 serving as an arithmetic unit to execute the program 402 in order to include a function that implements the present invention.

Moreover, the thin client terminal 400 includes an input interface 405 such as various types of keyboards and buttons that the computer apparatus generally has, and an output interface 406 such as a display, and a communication interface 407 that exchanges data, for example, between the traffic control system 100 and the thin client terminal 400, and between the thin client server 300 and the thin client terminal 400.

The foregoing thin client terminal 400 is a PC of a so-called HDD-less type and is configured so that a printer, an external drive, an external memory and the like cannot be coupled thereto through a local or network coupling. In other words, the thin client terminal 400 is configured so as to use only a printer, an external drive, an external memory and the like that are coupled to the thin client server 300 through a local or network coupling. Thereby, the possibility of information leakage caused by theft of the thin client terminal 400 or the like is reduced.

Moreover, the thin client terminal 400 has an I/O connector 460 for coupling a keyboard and a mouse, and a video card for coupling a display. Further, the thin client terminal 400 can store the program 402, which implements the units 110, 111 and 113 of the system 100, in the flash ROM 480.

Additionally, in the present embodiment, the thin client terminal 400 stores the program 402, which implements the units 110, 111 and 113, a remote client program 470 and an encrypted communication program 471 in the flash ROM 480.

Furthermore, the thin client terminal 400 includes a chip which is called a TPM (Trusted Platform Module) 401. The TPM 401 has a function similar to that of a security chip mounted on a smart card (IC card), and is a hardware chip having the functions of performing an asymmetric-key operation and the feature of tamper resistance for securely storing such keys. The TPM 401 provides the functions of, for example, generating and storing an RSA (Rivest-Shamir-Adleman Scheme) private key, performing an RSA private key operation (signature, encryption, decryption), aSHA-1 (Secure Hash Algorithm 1) hash operation, storing platform status information (software measurement values) (PCR), maintaining the chain of trust for keys, certificates, and credentials, generating a high quality random number, and other functions as a non-volatile storage, Opt-in, I/O and on the like.

The TPM provides the functions of securely storing platform status information (software measurement values) in a resister PCR (Platform Configuration Registers) in the TPM 401 and reporting this information, in addition to the functions of the encryption key (asymmetric-key) generation/storage/operation. According to the latest specification, the TPM 401 further includes the functions of locality, delegation (delegation of authority), and the like. Incidentally, the TPM 401 is physically disposed on a component of a platform (motherboard or the like).

In the present embodiment, the thin client terminal 400 stores the remote client program 470 and the encrypted communication program 471 in the flash ROM 480. The encrypted communication program 471 uses the aforementioned functions of the TPM when encryption is performed. The remote client program 470 is a program with which the thin client terminal 400 gains access to the desktop of the thin client server 300 remotely, and a VNC client (viewer) program is taken as an example. The CPU 404 loads the remote client program 470 into the RAM 403 from the flash ROM 480 to execute the program according to the OS. Thereby, the CPU 404 transmits input information of the I/O connector 460 (operation contents inputted by the keyboard and the mouse) to the thin client server 300 via the network 140 such as VPN, and outputs image information transmitted from the thin client server 300 (desk top screen of the display) to the input/output interface 405 such as a display coupled to the video card via the network 140 such as VPN.

The encrypted communication program 471 is a communication program for constructing a secure communication network such as VPN between the thin client terminal 400 and the thin client server 300 having an address notified by the remote client program 470. For example, a communication program using IPsec can be assumed. The CPU 404 loads the encrypted communication program 471 into the RAM 403 from the flash ROM 480 to execute the program according to the OS. Thereby, the CPU 404 transmits a communication start request to the thin client server 300 assigned to its thin client terminal 400 via the communication interface 407 to thereby construct a network such as VPN between the thin client server 300 and the thin client terminal 400, and performs remote control communications with the thin client server 300 via the VPN or the like.

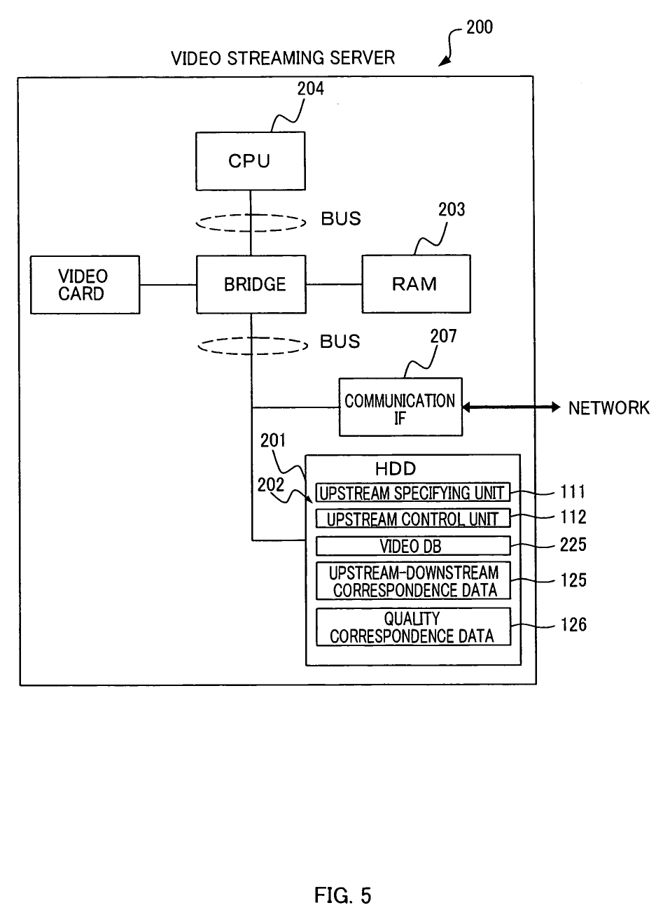

Next, descriptions will be given of the video streaming server 200. FIG. 5 is a view showing a configuration example of the video streaming server 200 of the present embodiment. The video streaming server 200 is a server apparatus that is coupled to the thin client server 300 via the communication line B and performs video streaming to the thin client server 300. The video streaming server 200 includes a CPU 204, a RAM 203, and a storage device 201 that stores a program 202. The video streaming server 200 reads the program 202 stored in the storage device 201 (for example: hard disk drive) into the RAM 203 and causes the CPU 204 serving as an arithmetic unit to execute the program 202.

Moreover, the video streaming server 200 includes an input interface 205 such as various types of buttons and an output interface 206 such as a display, a speaker, and the like if necessary, and a communication interface 207 that performs video data transmission to the thin client server 300. Naturally, it is assumed that the video streaming server 200 stores a video database 225 that stores video data to be distributed to the thin client server 300 in a storage device such as a hard disk drive. The aforementioned video streaming server 200 can include the program 202 which implements the units 111 and 112 of the system 100.

It should be noted that the units 110 to 113 in the traffic control system 100, the video streaming server 200, the thin client server 300, the thin client terminal 400, and the like shown so far may be implemented as hardware, or may be implemented as programs stored in an appropriate storage device such as a memory, a HDD (Hard Disk Drive) or the like. In this case, the CPU of each apparatus reads the program from the storage device into the corresponding memory in response to program execution, and executes the program.

Regarding the network 140, it is possible to employ networks of various types such as an ATM line, a leased line, a WAN (Wide Area Network), a power line communication (PLC) network, a wireless network, a public network, a mobile-phone network, and on the like, in addition to the Internet and a LAN. In addition, use of a virtual dedicated network technique such as VPN (Virtual Private Network) is preferable when the Internet is employed since communications having improved security is established.

### Database Structure

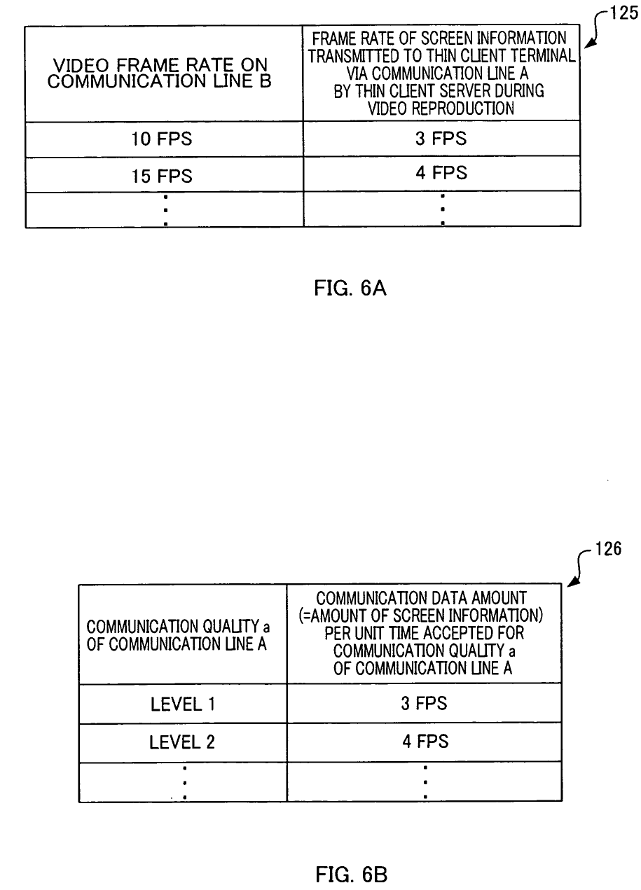

Next, descriptions will be given of structures of tables of various types that the traffic control system 100 of the present embodiment can use. FIGS. 6A and 6B are tables respectively showing data structure examples of: (A) the upstream-downstream correspondence data 125; and (B) the quality correspondence data 126 in the present embodiment.

The upstream-downstream correspondence data 125 is a table that describes a relation between an amount of streaming data which is received by the relay server from the video streaming server via the communication line B (for example, a protocol for a streaming communications) and then is subjected to reproduction processing by the relay server, and an amount of screen information transmitted to the communication line A (for example, a protocol for a remote desktop communications) from the thin client server 300 in response to the reproduction processing. For example, the upstream-downstream correspondence data 125 is an assembly of records each in which a frame rate of screen information transmitted to the thin client terminal 400 via the communication line A by the thin client server 300 during the video reproduction, is associated with a video frame rate on the communication line B.

Further, the quality correspondence data 126 is a table that describes a relation between a communication data amount accepted for the communication quality a of a communication line and an amount of screen information corresponding to the communication data amount. For example, the quality correspondence data 126 is an assembly of records each in which a communication data amount per unit time accepted for the communication quality a of the communication line A (for example: a data amount of data size and transmission speed of screen information where no problem of delay or the like occurs in an output result by the thin client terminal 400 as a result of transmission by the communication quality a), is associated with the amount of screen information, corresponding to the communication data amount accepted for the communication quality a.

### Processing Flow Example 1

Descriptions will be given of an actual procedure of a traffic control method of the present embodiment below on the basis of the drawings. It should be noted that the operations corresponding to the traffic control method to be described below are implemented by programs that are read into RAMs of the thin client terminal 400 and the thin client server 300 which are serving as the traffic control system 100 and are executed by the CPU. Moreover, the program is formed of codes for performing various types of operations to be described below. In the present embodiment, descriptions will be given, as an example, on the assumption that the thin client terminal 400 includes the quality measuring unit 110 and the thin client server 300 includes the upstream specifying unit 111, upstream control unit 112, and downstream control unit 113.

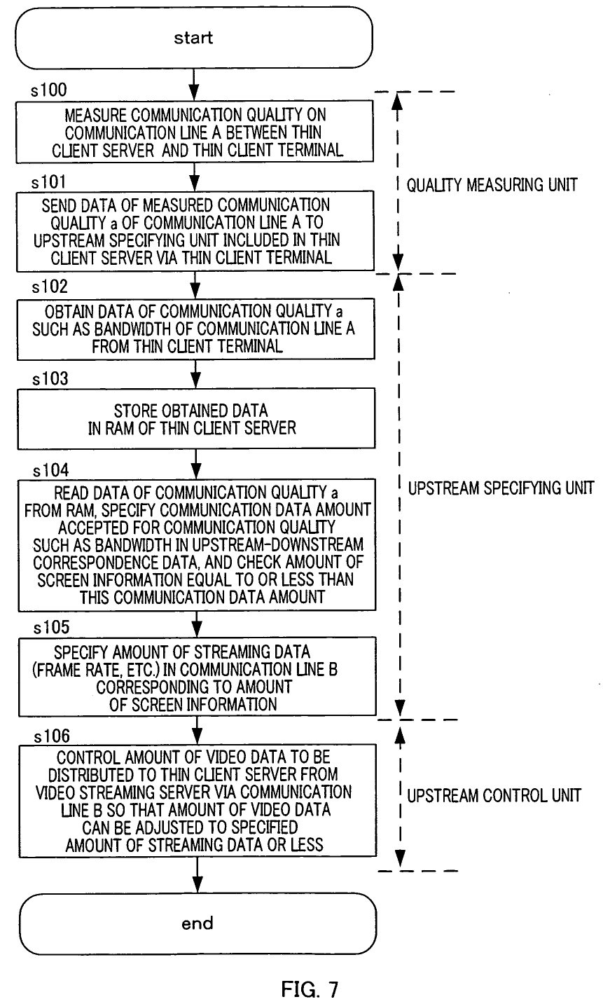

FIG. 7 is a view showing a processing flow example 1 of a traffic control method in the present embodiment. First, the quality measuring unit 110 included in the thin client terminal 400 measures communication quality on a communication line A between the thin client server 300 and the thin client terminal 400 (S100). In a state where, for example, at least one of a bandwidth and transmission speed of the communication line A is taken as an object to be measured, the communication quality measurement is executed by passive measurement (response time measurement of screen data sent from the thin client server 300 in response to an input operation by the thin client terminal 400, fluctuation measurement of ACK response time and the like) and active measurement (response time measurement of response data sent from the thin client server 300 in response to ping transmission, and the like).

The quality measuring unit 110 sends data of the measured communication quality a of the communication line A to the upstream specifying unit 111, which is included in the thin client server 300, via the thin client terminal 400 (S101).

Meanwhile, the upstream specifying unit 111 of the thin client server 300 obtains data of the communication quality a such as a bandwidth or the like of the communication line A from the thin client terminal 400 (S102) and stores it in the RAM 303 of the thin client server 300 (S103). Then, the upstream specifying unit 111 reads data of the communication quality a such as a bandwidth or the like from the RAM 303, specifies a communication data amount (throughput or the like) accepted for, for example, a certain bandwidth (communication quality) in the upstream-downstream correspondence data 125, and checks an amount of screen information equal to or less than the communication data amount. This checking specifies an amount of streaming data (frame rate or the like), in the communication line B, corresponding to the amount of screen information (S105).

In other words, for example, in a communication line having a certain bandwidth, a maximum communication data amount per unit time for maintaining good communication speed is specified and an amount of screen information (per unit time), which is equal to or less than the communication data amount, is specified.

Next, the upstream control unit 112, which is included in the thin client server 300, performs control such that an amount of video data to be distributed to the thin client server 300 from the video streaming server 200 via the communication line B can be adjusted to the specified amount of streaming data (S106). In this case, processing by the upstream control unit 112 is one for instructing the thin client server 300 to assign the specified amount of streaming data (frame rate or the like) as video streaming quality to be requested to the video streaming server 200 by the thin client server 300 requests. By performing such an instruction, the thin client server 300 requests video streaming with the forgoing amount of streaming data from the video streaming server 200, receives the video streaming from the video streaming server 200 accordingly, reproduces the distributed video data, and transmits screen information at this time to the thin client terminal 400 via the communication line A.

Alternatively, the upstream control unit 112 may assign the specified amount of streaming data to the video streaming server 200 as video streaming quality that the video streaming server 200 distributes to the thin client server 300. By performing such an instruction, the video streaming server 200 performs video streaming having a frame rate (amount of distribution) suitable for the communication quality a of the communication line A to the thin client server 300 from the beginning.

It should be noted that the aforementioned upstream control unit 112 can be regarded as a band control device that controls a bandwidth of the communication line B. For instance, PacketShaper® (Packeteer, Inc.) is taken as an example of the band control device.

Thus, according to the communication quality a of the communication line A (downstream side) between the thin client server 300 and the thin client terminal 400 in the thin client system, the frame rate of the video streaming (upstream side) to the thin client server 300 from the video streaming server 200 is reduced in advance. This prevents data delay and congestion due to a difference in communication quality between the communication lines A and B to smooth video reproduction under a remote desktop couple environment between the thin client server 300 and the thin client terminal 400.

### Processing Flow Example 2

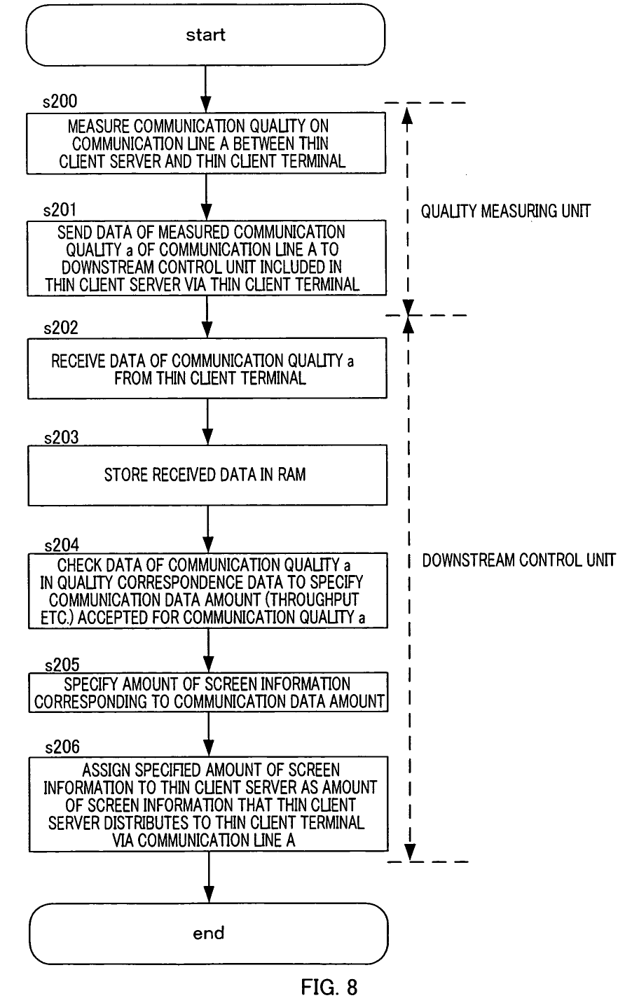

FIG. 8 is a view showing a processing flow example 2 of the traffic control method of the present embodiment. Moreover, as another example, for example, a case where the thin client server 300 includes the downstream control unit 113 can be assumed. In this case, the quality measuring unit 110, which is included in the thin client terminal 400, measures communication quality of the communication line A between the thin client server 300 and the thin client terminal 400 (S200). Further, the quality measuring unit 110 sends data of the measured communication quality a of the communication line A to the downstream control unit 113, which is included in the thin client server 300, via the thin client terminal 400 (S201).

Meanwhile, the downstream control unit 113 of the thin client server 300 receives data of the communication quality a from the thin client terminal 400 (S202) and stores it in the RAM 303 (S203). Subsequently, the downstream control unit 113 checks data of the communication quality a such as a bandwidth read from the RAM 303 in the quality correspondence data 126 and specifies a communication data amount (throughput or the like) accepted for the communication quality a (S204), and specifies an amount of screen information corresponding to the communication data amount (S205).

In other words, for example, in a communication line having a certain bandwidth, a maximum communication data amount per unit time for maintaining good communication speed is specified and an amount of screen information (per unit time), which is equal to or less than the communication data amount, is specified.

Subsequently, the downstream control unit 113 assigns the specified amount of screen information to the thin client server 300 as an amount of screen information that the thin client server 300 distributes to the thin client terminal 400 via the communication line A (S206). Thus, according to the communication quality a of the communication line A between the thin client server 300 and the thin client terminal 400 in the thin client system, an amount of transmission of screen information per unit time to the thin client terminal 400 from the thin client server 300 is appropriately reduced. As a result, even if there is a difference in communication quality between the communication lines A and B, the thin client server 300 operates like a buffer to offset the difference in communication quality, and prevents existing data delay and congestion to smooth video reproduction under a remote desktop couple environment between the thin client server 300 and the thin client terminal 400.

According to the present embodiment, screen information produced during video reproduction by the server can be transmitted to the client according to network quality.

Although the present invention has been described above specifically on the basis of the embodiment thereof, the present invention is not limited to this, and various changes can be made thereto without departing from the scope of the invention.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A traffic control system which is an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the traffic control system comprising:
a quality measuring unit configured to measure communication quality on a communication line A between the relay server and the client terminal;
an upstream specifying unit configured to specify an amount of streaming data, in a communication line B between the video streaming server and the relay server, corresponding to an amount of the screen information of a communication data amount accepted for the measured communication quality a of the communication line A; and
an upstream control unit configured to perform control such that an amount of video data distributed to the relay server from the video streaming server via the communication line B is adjusted to the specified amount of streaming data.

2. A traffic control system which is an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the traffic control system comprising:
a quality measuring unit configured to measure communication quality on a communication line A between the relay server and the client terminal; and
a downstream control unit configured to perform control such that an amount of screen information transmitted to the client terminal from the relay server via the communication line A is adjusted to a communication data amount accepted for the measured communication quality a of the communication line A.

3. The traffic control system according to claim 1, wherein
the quality measuring unit is included in any one of the client terminal, the relay server, and an external device disposed in a path of the communication line A, and measures at least one of a bandwidth and transmission speed of the communication line A.

4. The traffic control system according to claim 2, wherein
the quality measuring unit is included in any one of the client terminal, the relay server, and an external device disposed in a path of the communication line A, and measures at least one of a bandwidth and transmission speed of the communication line A.

5. The traffic control system according to claim 1, wherein
the upstream specifying unit includes upstream-downstream correspondence data describing a relation between an amount of streaming data which is received by the relay server from the video streaming server via the communication line B and then is subjected to reproduction processing by the relay server, and an amount of screen information transmitted to the communication line A from the relay server in response to the reproduction processing, and
the upstream specifying unit checks the amount of screen information of the communication data amount accepted for the communication quality a in the upstream-downstream correspondence data, and specifies an amount of streaming data, in the communication line B, corresponding to the amount of screen information.

6. The traffic control system according to claim 1, wherein
the upstream control unit performs any one of processing of instructing the relay server to assign the specified amount of streaming data as video streaming quality to be requested to the video streaming server by the relay server requests, and processing of assigning, to the video streaming server, the specified amount of streaming data as video streaming quality to be used for vide streaming distribution to the relay server by the video streaming server.

7. The traffic control system according to claim 1, wherein
the upstream control unit is a band control device that performs control to adjust a bandwidth of the communication line B.

8. The traffic control system according to claim 2, wherein
the downstream control unit includes quality correspondence data describing a relation between a communication data amount accepted for the communication quality of a communication line, and the amount of screen information corresponding to the communication data amount, and
the downstream control unit checks the communication data amount accepted for the communication quality a in the quality correspondence data to specify the amount of screen information corresponding to the communication data amount, and assigns the specified amount of screen information to the relay server as an amount of screen information to be distributed to the thin client terminal by the relay server via the communication line A.

9. The traffic control system according to claim 1,
wherein the relay server and the client terminal constitute a thin client system where the relay server is a thin client server and the client terminal is a thin client terminal,
a protocol of the communication line A is a protocol for remote desktop coupling communications, and
a protocol of the communication line B is a protocol for streaming communications.

10. The traffic control system according to claim 2,
wherein the relay server and the client terminal constitute a thin client system where the relay server is a thin client server and the client terminal is a thin client terminal,
a protocol of the communication line A is a protocol for remote desktop coupling communications, and
a protocol of the communication line B is a protocol for streaming communications.

11. A traffic control method for an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the method comprising:
the information processing system performing quality measuring processing for measuring communication quality on a communication line A between the relay server and the client terminal;
the information processing system performing upstream specifying processing for specifying an amount of streaming data, in a communication line B between the video streaming server and the relay server, corresponding to an amount of screen information of a communication data amount accepted for the measured communication quality a of the communication line A; and
the information processing system performing upstream control processing for performing control such that an amount of video data distributed to the relay server from the video streaming server via the communication line B is adjusted to the specified amount of streaming data.

12. A traffic control method for an information processing system that controls traffic among a video streaming server, a relay server having a video reproduction program for reproducing video data distributed from the video streaming server, and a client terminal that receives screen information corresponding to the reproduced video data from the relay server and outputs the screen information on a screen, the method comprising causing the information processing system to execute:
quality measuring processing for measuring communication quality on a communication line A between the relay server and the client terminal; and
downstream control processing for performing control such that an amount of screen information transmitted to the client terminal from the relay server via the communication line A is adjusted to a communication data amount accepted for the measured communication quality a of the communication line A.
